(19) United States
(12) Patent Application Publication
(10) Pub. No.: US 2017/0361652 A1
(43) Pub. Date: Dec. 21, 2017

(54) ROLLING DEVICE, ESPECIALLY FOR FURNITURE, LUGGAGE CASES AND THE LIKE

(71) Applicant: Romualdo Monteiro de Barros, Rio de Janeiro (BR)

(72) Inventor: Romualdo Monteiro de Barros, Rio de Janeiro (BR)

(21) Appl. No.: 15/186,699

(22) Filed: Jun. 20, 2016

(51) Int. Cl. B60B 33/08; A45C 5/14; B60B 33/00

(52) U.S. Cl. CPC B60B 33/08; B60B 33/0065; A45C 5/143; B60B 33/006

(57) ABSTRACT

The present utility model refers to a rolling device and, more particularly, an improved multi-directional ball caster-type device having a better contact angle between the ball and the ground. The contact angle of the present improved device is from 62° to 50°, or less. As the contact angle can be smaller, the object supported on the rolling system can be more sloped, for example, a luggage case, without having friction between the main ball involving structure and the ground.

### RELATED APPLICATIONS AND INCORPORATION BY REFERENCE

Reference is made to BR 102014012724 published 22 Dec. 2015 by the inventor and as such BR 102014012724 is not available as prior art under post-AIA 35 U.S.C. 102(a)(1), but is excluded from being available as prior art pursuant to post-AIA 35 U.S.C. 102(b)(1).

### TECHNICAL FIELD

The present utility model refers to a rolling device and, more particularly, an improved multi-directional ball caster-type device. The utility model also relates to a method for manufacturing a rolling ball device, as well as a simple and safe method for assembling and installing a rolling ball device.

### BACKGROUND OF THE UTILITY MODEL

Generally, rolling devices are widely used in furniture, such as chairs and tables, baby strollers or baby prams, supermarket trolleys, and toys, as well as in luggage cases, bags, backpacks and the like.

Examples of ball caster-type rolling devices can be found in documents of the prior art, such as, for instance, the device disclosed in the Chinese patent document CN 2,739,021, entitled “Vertical Universal Caster”, filed in the name of Xu Haikang and published on Nov. 09, 2005. This Chinese prior art document discloses a rolling device having a main rolling ball and two rings of secondary rolling balls, the rings have different diameters and they are enclosed by a two-part structural member. The upper structural member has two grooves to fit both rings. The device has still a supporting structure that is fixed to an object in which is to be installed.

However, the device taught in the Chinese patent document CN 2,739,021 has some disadvantages. Firstly, the assembly of its parts is complex, because both rings of balls are fitted to the same and unique upper structural member. Furthermore, the attachment thereof to the object to be used is entirely external, thereby rendering the device very large.

Another example of a prior art rolling device is disclosed in U.S. Pat. No. 7,578,028, entitled “Device for providing multi-directional movement”, in the name of Robert Sellars, published on May 18, 2006 and granted on Aug. 25, 2009. The document U.S. Pat. No. 7,578,028 discloses a device for providing a multi-directional movement, comprising a two-part housing that encloses a main rolling ball and two rings of secondary rolling balls or ball rollers. The members of the device are stacked on top each other, and the secondary rolling balls are located in a recessed area defined by the inner walls of the housing.

Furthermore, the device disclosed in U.S. Pat. No. 7,578,028 also fails concerning the mere stacking of the members on top each other, not providing a suitable interaction between all the parts, making the rolling device liable to failure and lockings in use.

Likewise, as in the case of the rolling device of the prior art document CN 2,739,021, since the fixing the device shown in the U.S. Pat. No. 7,578,028 to the object to be used is totally external, the rolling device will be less compact.

The Brazilian patent application BR 10 2014 012724-0 discloses a multi-directional rolling device comprising lower and upper structural members, each one having at least one groove, or recessed area, to receive enveloped rings of rolling balls, and a main rolling ball enclosed by the lower and upper structural members. The Brazilian patent application BR 10 2014 012724-0 also refers to a method for assembling the rolling device. However, the prior art rolling device taught in the Brazilian patent application does not work in such a way to give a contact angle less than 62°, thereby making difficult to install the device in objects that require smaller angular slope levels.

Accordingly, in view of the restrictions and/or the disadvantages of the caster devices of the state-of-the-art, the present inventor has designed a new rolling ball device having a better performance, without having the limitations of the already known multi-directional movement devices.

The utility model of the present utility model has an structural configuration that makes possible to considerably decrease the size of the supporting structure in its wholly, since both rolling rings, which hold the larger ball, were brought into a closer arrangement. In short, the lower rolling ring surrounds the main rolling ball in a region nearer to its center, while still making possible to hold the main rolling ball within the device, and, at the same time, increasing the distance between the base of the structure and the ground, thereby optimizing the contact angle therebetween.

More specifically, the utility model of the present utility model provides a contact angle between the main rolling ball and the ground less than 62°, preferably 50°. This feature allows the installation of the device in objects that require smaller angular slope levels, such as, for example, luggage cases.

Accordingly, the advantages of the utility model of the present utility model in relation to the state-of-the-art are accomplished by the optimization of the integral structure, and, in particular, by the novel position of the rings of rolling balls, which provides a better contact angle between the main ball and the ground, the contact angle having been decreased from 62° to 50°, or less. As the contact angle can be smaller, the object supported on the rolling system can be more sloped, for example, a luggage case, without having friction between the main ball involving structure and the ground.

### BRIEF DESCRIPTION OF THE UTILITY MODEL

The present utility model refers to an improved multi-directional ball caster-type device, comprising lower and upper structural members, each one having at least one groove to receive enveloped rings of rolling balls, so called bearing rings, and a main rolling ball, also called main spherical roller, enclosed by the lower and upper structural members, wherein the lower rolling ring surrounds the main rolling ball in a region nearer to its center, while still making possible to hold the main rolling ball within the device, and, at the same time, increasing the distance between the base of the structure and the ground, thereby optimizing its contact angle with the ground. Preferably the mentioned groove is a continuous groove and very preferably the groove extends in a circumferential direction around at least one section of the main rolling ball. Preferably et least one of the lower structural members and the upper structural member is designed in one piece. Preferably the lower structural member and the upper structural member form a contact surface, which contact surface extends preferably in a geometrical plane. In another preferred embodiment a fixation means is comprised which fixes the lower structural member to the upper structural member. Preferably the lower rolling ring has a greater diameter than the upper rolling ring. Preferably the diameter of the lower rolling ring and the diameter of the upper rolling ring are in a relation which is between 1:1,1 and 1:2. Preferably the lower rolling ring forms a first geometrical plane and the upper rolling ring forms a second geometrical plane, wherein preferably these planes are parallel with respect to each other and wherein most preferably a distance between these planes is smaller than the diameter of the main rolling ball, preferably smaller than 90% of the diameter of the main rolling ball, preferably smaller than 80% of the diameter of the main rolling ball, preferably smaller than 70% of the diameter of the main rolling ball. Preferably a distance between these planes is bigger than 10% of the diameter of the main rolling ball, preferably bigger than 20% of the diameter of the main rolling ball, preferably bigger than 30% of the diameter of the main rolling ball.

Further, the present utility model refers to a method for installing the improved rolling ball system, so called ball caster.

One purpose of the present utility model is to provide a much more compact multi-directional rolling ball device, thereby being required a smaller space to fit the device to the object to be moved.

Another purpose of the present utility model is to provide a multi-directional rolling ball device, which can be easily and safely assembled and that avoids failures and lockings in use.

It is still another object of the present utility model to provide a multi-directional rolling ball device, which can be quickly assembled and that requires few parts or members to result in an improved rolling.

The main purpose of the present utility model is the construction of a multi-directional rolling ball device that makes possible an inner rolling of 360°, in all axes, thereby allowing the free displacement, in all directions, of the load supported by the device.

According to one embodiment of the present utility model, the multi-directional rolling ball device supports loads with weights varying from 80 kg to 150 kg, depending on the intended use of the device, without causing failures or damages in the rolling system.

According to another embodiment of the present utility model, the distance between the surface and the base of the multi-directional rolling ball device is calculated so as to minimize the whole size of the device and so as to provide the normal angles for its applicability.

According to an optional embodiment of the present utility model, the multi-directional rolling ball device has an integrated safety system for braking and for fixing or holding the load to be supported. This safety means can be designed among other as a clamp system which prevents a rotation of the main ball with respect to the lower and upper structural members. Preferably at least on structural member forms a receiving space for the main rolling ball, suitable to house at least 40% of the volume of the main rolling ball, preferably at least 50% of the volume of the main rolling ball and most preferably at least 60% of the volume of the maining rolling ball.

The purposes of the present utility model are attained by providing a multi-directional rolling ball device comprising a lower structural member (base); an upper structural member (housing); a main rolling ball enclosed by the lower and upper structural members; the lower structural member having at least one lower groove (recessed area); the upper structural member having at least one upper groove (recessed area); at least one ring of secondary rolling balls being fitted within the at least one lower groove; the at least one lower and one upper rings of secondary rolling balls fitted within their respective lower and upper structural members, wherein each one of the rings of secondary rolling balls is an enveloped set of secondary balls.

The purposes above mentioned are further attained by providing a method for installing the multi-directional rolling ball device of the utility model.

### BRIEF DESCRIPTION OF THE DRAWINGS

The present utility model will be better understood by means of the description herein below, together with the appended Figures, wherein:

FIG. 1 represents a perspective view of the multi-directional rolling ball device (1), showing especially the main rolling ball (1.1), in direct contact with the surface of the device and the surface of the smaller balls (1.21, 1.31), which are within the lower (1.2) and the upper (1.3) rings.

FIG. 2 represents a perspective view of the multi-directional rolling ball device, especially showing lower (1.2) and upper (1.3) rings of balls.

FIGS. 3a and 3b show, in detail, the lower (1.2) and the upper (1.3) rings, respectively, where there are the smaller balls (1.21, 1.31). These rings of balls are the rolling rings responsible for the contact between the main rolling ball (1.1) and the inner wall of the device, thereby enabling a rolling of 360°, in all axes.

FIG. 4 specifically illustrates the lower structural member (1.4), consisting of a lower part (base), having the purpose of arranging both the main rolling ball (1.1) and the lower ring of rolling balls (1.2) consisting of smaller balls (1.21).

FIG. 5 specifically illustrates the upper structural member (1.5), consisting of an upper part (housing) having the purpose of arranging the upper ring of rolling balls (1.3), working as an indirect support for the main rolling ball (1.1).

FIG. 6 is a front view of the multi-directional rolling ball device (1), showing its interior details, and especially the grooves (1.41, 1.51) of the lower and upper structural members (1.4, 1.5), respectively, which receive the rings (1.2, 1.3).

FIGS. 7a and 7b illustrate the fitting of the set comprising the lower structural member (1.4) coupled with the lower ring of rolling balls (1.2) and with the main rolling ball (1.1), which is inserted into a central opening (1.42), the set being used in an object to which the multi-directional rolling ball device (1) is to be fitted.

FIG. 8 is a front view of the multi-directional rolling ball device (1) after being assembled.

FIGS. 9a and 9b show two perspective views of different multi-directional ball caster-type systems, one representing the state-of-art and the other one representing the present utility model. The different movement of the rolling ball device of the present utility model shows the advantage of having a higher slope caused by the improvements of the rolling ball device as herein disclosed and claimed in relation to other devices of the prior art. The rolling ball device shown in FIG. 9a is an example of the device of the state of the art, wherein the maximum slope angle is of 62°. Differently, from the rolling ball device of FIG. 9b, it can be noted that the novel arrangement and the new shape of the parts of the rolling ball device according to the present utility model allows to attain an angle of 50°, or even smaller.

FIGS. 10a and 10b are bottom and top perspective views, respectively, of the multi-directional rolling ball device (1) as mounted.

It must be understood that the multi-directional rolling ball device (1) of the present utility model and their respective parts shown in the appended Figures are only an example of one embodiment of the object herein claimed and it is not intended to limit the scope of protection of the utility model.

### DETAILED DESCRIPTION OF THE UTILITY MODEL

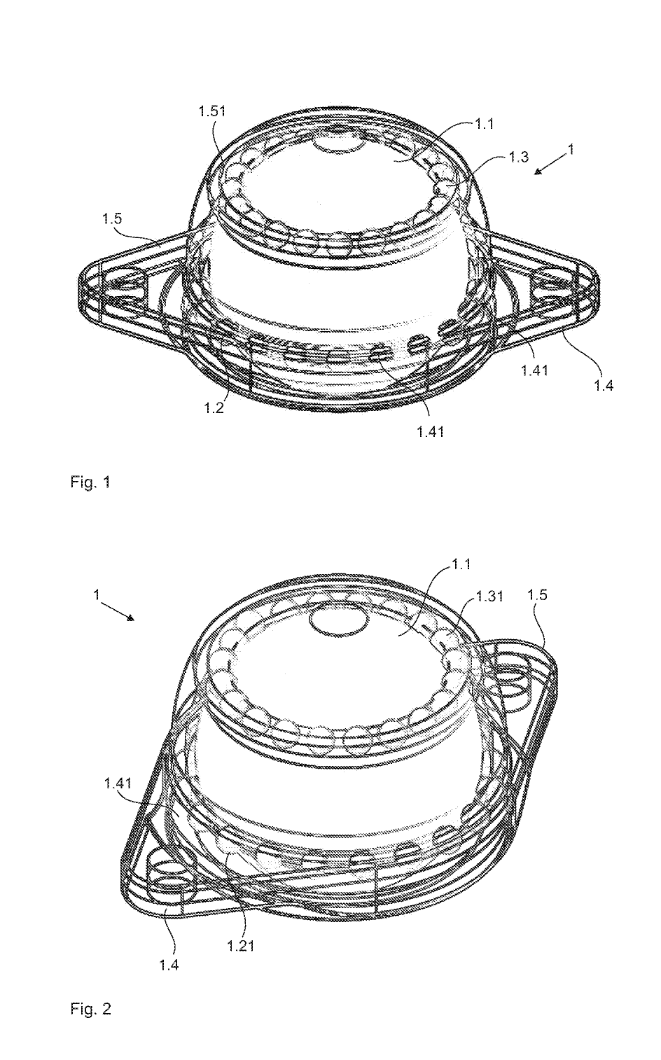

FIGS. 1 and 2 illustrate the multi-directional rolling device (1), which comprises a lower structural member (1.4) and an upper structural member (1.5), which enclose a main rolling ball (1.1). Each one of the lower and upper structural members (1.4, 1.5) has, at its internal surface, at least one groove (1.41, 1.51) to receive lower and upper secondary rolling balls (1.2, 1.3).

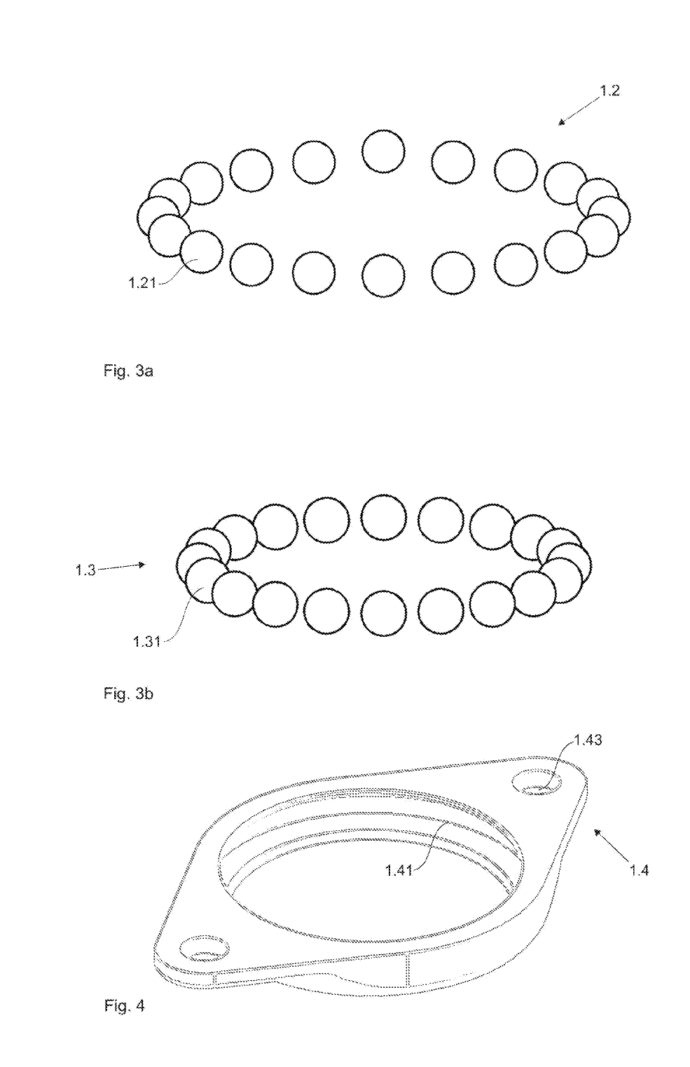

FIG. 3 illustrates lower and upper rings (1.2, 1.3), respectively, composed of secondary rolling balls (1.21, 1.31). Each one of these rings has to be fitted to at least one groove (1.41, 1.51) of its respective structural member (1.4, 1.5), as shown in FIGS. 4, 5 and 6.

The rings of secondary rolling balls (1.2, 1.3) are responsible for allowing the rolling at 360° in all axes, thereby making possible the free movement, in all directions, of the load supported by the multi-directional rolling device (1). Preferably, the secondary rolling balls (1.21, 1.31) have the same size and they are made of the same material. The properties of the material used for making the bearings or rollers, also called rollings, determine the extension of the friction that will happen, a key factor that affects the durability thereof. The bearings or rollers, also called rollings, are preferably made of a light material having a low friction coefficient, such as tungsten, aluminum, carbon steel alloys and even some non-metallic materials, chosen depending on the intended use.

According to a preferred embodiment of the present utility model, a thin adhesive tape sticks the balls (1.21, 1.31) in a ring shape. The role of the adhesive tape is to maintain the balls together, thereby facilitating the installation. After finishing the installation procedure, the adhesive tape decompose due to the rolling of the device. An example non-limitative of the material that could be used for such a purpose is a vegetable paper. Preferably in use the secondary rolling balls are not held by a ball cage. It is also possible however, that a ball cage is provided, which allows a rotation of the secondary rolling balls around at least two rotational axes which deviate from each other.

As it can be understood from FIGS. 3a, 3b, the rings (1.2, 1.3) are built by enveloping the secondary rolling balls (1.21, 1.31). The envelopment or wrapping assures that the secondary rolling balls are maintained at a preset position, preventing their displacement when the rings are being inserted into the grooves (1.41, 1.51). When the multi-directional rolling device (1) is been used, the envelopment of the rings of secondary rolling balls breaks off and/or decompose due to the friction between the rings of secondary rolling balls (1.21, 1.31) and the main rolling ball (1.1).

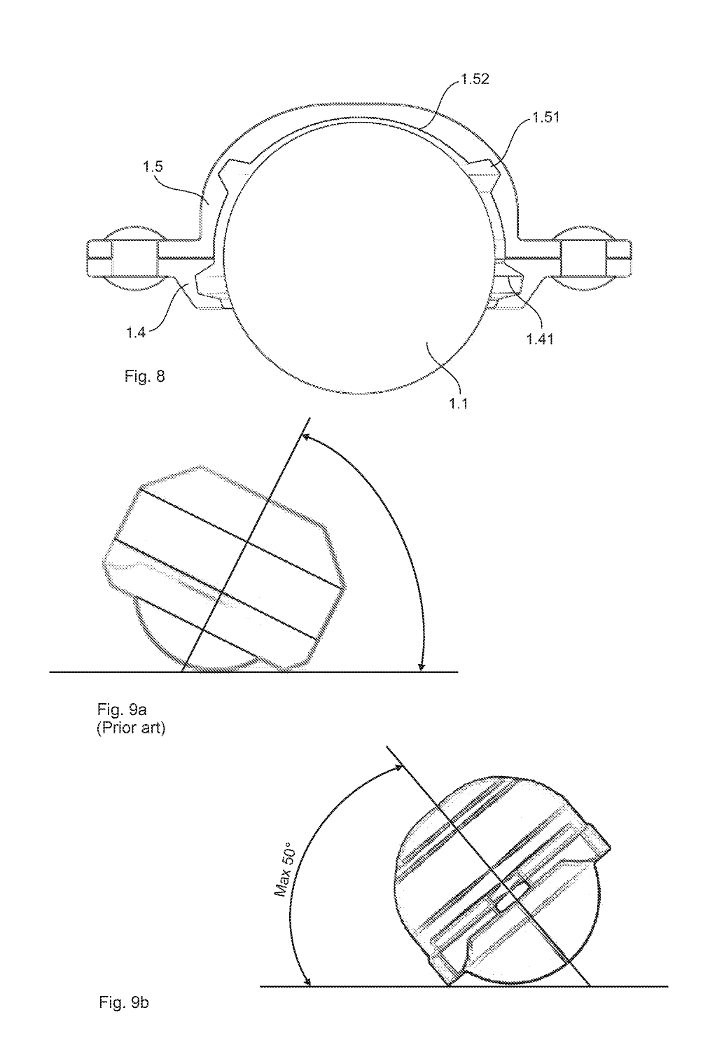

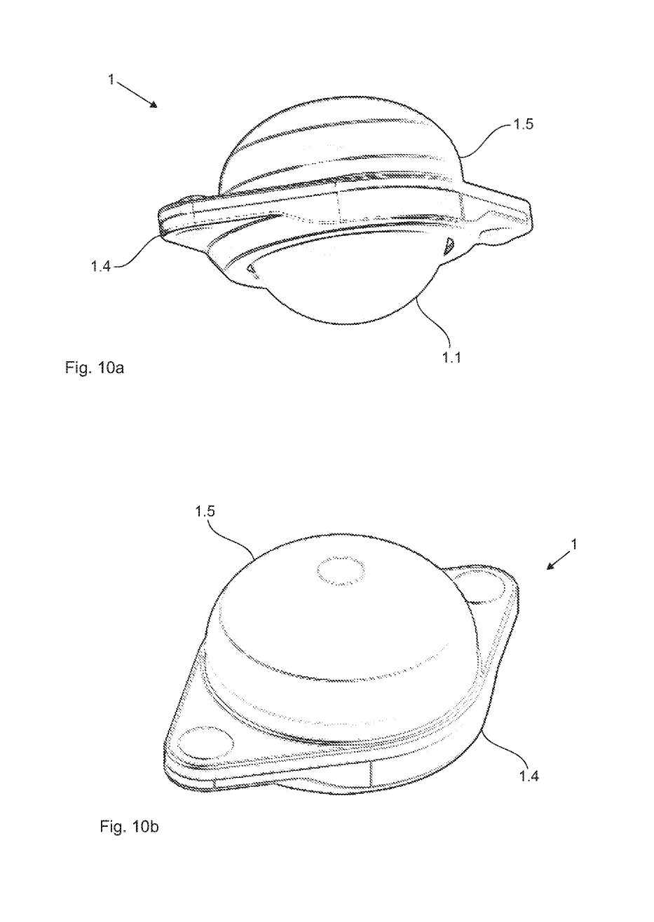

The appended FIGS. 1 to 10 clearly show how the claimed device works. In short, the surface of the main rolling ball (1.1) enters into contact with the surfaces of the secondary rolling balls (1.21, 1.31). Accordingly, the rings of secondary rolling balls (1.2, 1.3) execute the contact between the main rolling ball (1.1) and the inner wall of the lower and the upper structural members (1.4, 1.5), respectively. These inner walls might be of a hardened structure. Such rings (1.2, 1.3) are inserted into the respective inner grooves (1.41, 1.51) of the lower and upper structural members (1.4, 1.5).

As it can be better noted in the FIG. 4, the lower structural member (1.4) comprises a groove (1.41) for fixing the lower ring (1.2). Furthermore, the lower structural member (1.4) comprises a central opening (1.42), which diameter is smaller than the diameter of the main rolling ball (1.1), causing the main rolling ball to be positioned on the lower structural member (1.4), thereby allowing the contact of the main rolling ball (1.1) with the surface on which the multi-directional rolling device will slide. The opening (1.42) having a diameter smaller than the diameter of the main rolling ball (1.1) further prevents the main rolling ball from being totally inserted within the multi-directional rolling device (1).

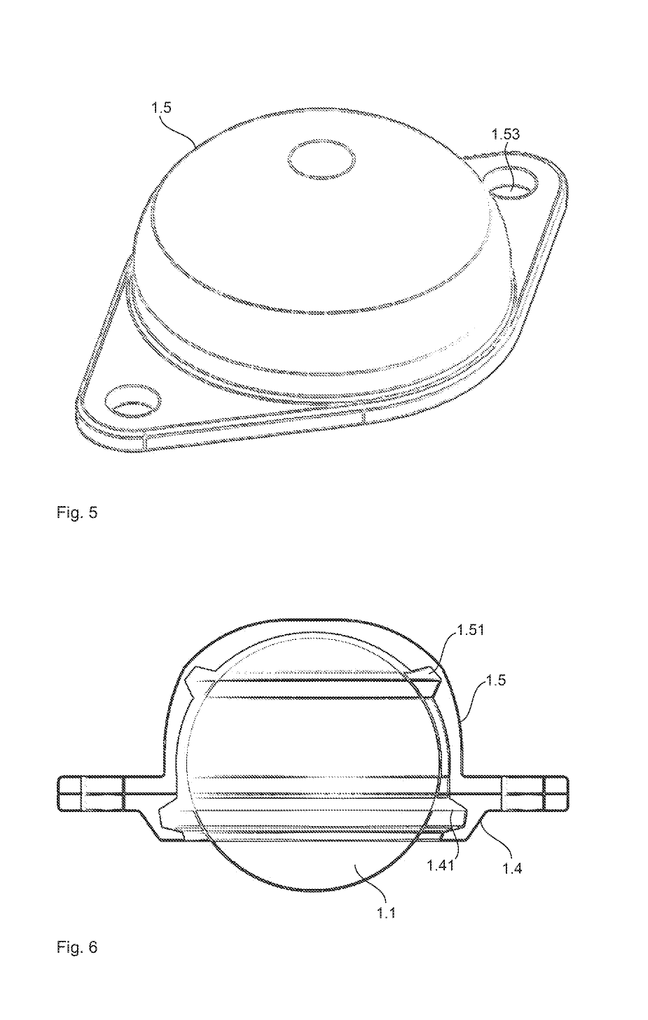

As it can be better noted from FIG. 5, the upper structural member (1.5) comprises a groove (1.51) to fit the upper ring (1.3). Moreover, it has a chamber (1.52) which encompasses the main rolling ball 1.1, making possible the contact of the main rolling ball (1.1) with the surface on which the multi-directional rolling device will enter into contact.

The grooves (1.41, 1.51), that respectively receive the rings (1.2, 1.3), are clearly shown in FIG. 6.

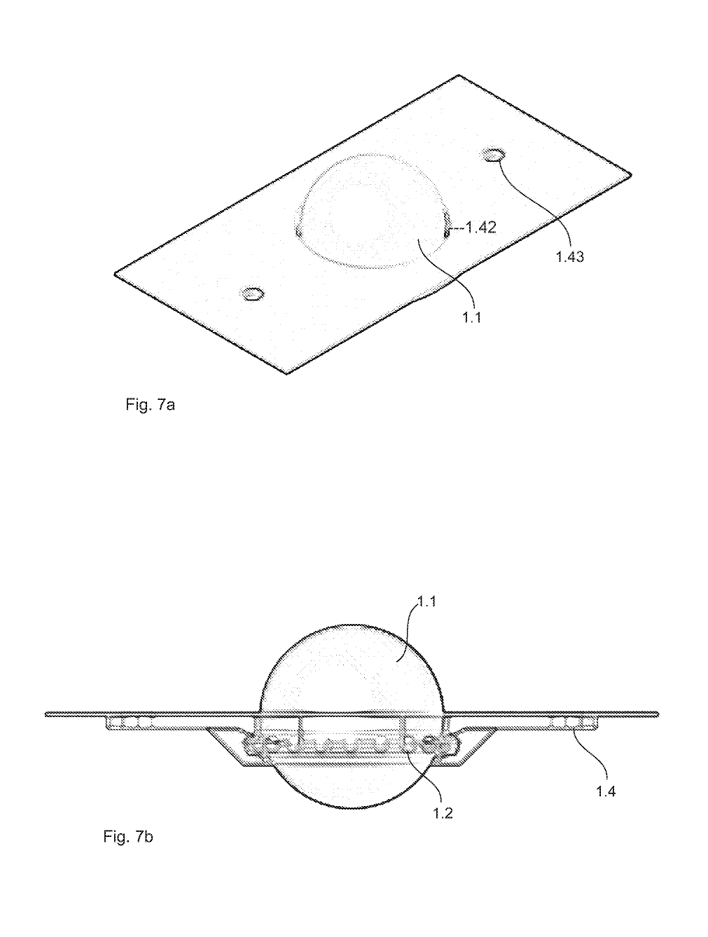

From FIGS. 7a and 7b, it can also be noted a non-limitative example of the coupling between the structural members (1.4, 1.5) of the multi-directional rolling device (1), and the coupling thereof with the object to which it will be fitted. The coupling can be performed, for instance, by fitting, riveting, screwing or gluing.

The upper structural member (1.5) can be connected to the lower structural member (1.4) by means of fitting means or else by screwing/riveting, using the existing holes (1.43, 1.53). The lower and upper structural members (1.4, 1.5), therefore, work as an indirect support to receive the main rolling ball (1.1).

The objects to which the multi-directional rolling device (1) can be fitted are, in general, for example, furniture, such as chairs and tables, baby strollers or baby prams, supermarket trolleys, and toys, as well as luggage cases, bags, backpacks and the like. After being fixed, the lower structural member (1.4) receives the ring of secondary rolling balls (1.2), which is placed in the at least one inner groove (1.42). Afterwards, the main rolling ball (1.1) is arranged within the lower structural member (1.4), and it will be in contact with the ring of secondary rolling balls (1.2). Subsequently, as it can be seen in FIG. 8, the installation of the upper structural member (1.5) is performed. The main rolling ball (1.1) is arranged in the chamber (1.52), enclosing, consequently, the multi-directional rolling device (1). The main rolling ball (1.1), when enclosed, contacts both rings of secondary rolling balls (1.2, 1.3).

FIG. 8 illustrates how is the interaction between the main rolling ball (1.1) and the other parts, which comprises the structure of the present device.

It should be noted that the distance between the surface of the object in which the multi-directional rolling device is to be used and the base of the rolling device has to be designed so as to minimize the whole size of all members to be used for manufacturing the device, as well as to allow more suitable angles during the use of the object to which the multi-directional rolling device (1) is to be fitted.

For example, when a multi-directional rolling device (1) is fitted to a luggage case, the device has to enable the object to tilt without adversely changing its performance. Accordingly, the smaller the slope angle of the rolling device is, the larger the gap between the device and the edge of the object to which the device is fitted must be.

Concerning the contact angle between the main rolling ball (1.1) and the ground, one knows that the smaller the contact angle is, the larger the slope of the object may be, without having friction with the ground. According to the main embodiment of the present utility model, the position of the rings of secondary rolling balls (1.2, 1.3) provides a better contact angle, of from 50° to 60°, and preferably 50° or less.

By means of example, each multi-directional rolling device (1), designed according to the present utility model, is able to support loads of up to 80 kg, or even greater without causing any locking of the rolling device system.

The multi-directional rolling device (1) has particularities which allow that it can be distinguished from the other devices shown in the prior art, and further it exhibits a number of other advantages, such as its system of balls, or bearings/rollers, arranged in a functional and safe way to the lower and upper structural members (1.4, 1.5), the innovative position of the rings of secondary rolling balls (1.2, 1.3) relative to the main ball rolling (1.1), making possible a contact angle less than 60°, which can be even less than 50°, between the main rolling ball (1.1) and the ground in relation to the object to which the device is fitted.

Moreover, after making many computer simulations and assessments, the inventor has verified the functional advantages of the claimed rolling device (1) compared with other similar devices already available. Some of the advantages are as follows:

Smaller contact angle between the device structure and the ground:

This advantage is, mainly, due to the innovative position of the center of the main rolling ball (1.1), which was taken away from the base of the lower structural member (1.4), thereby considerably decreasing the contact angle (maximum slope of the device without having friction with the ground). Moreover, changes in the dimensions or sizes of the lower structural member (1.4) and the innovative position of the rings (1.2, 1.3) also optimize the contact angle.

Design and Arrangement having an optimized sizing. The changes make possible structural improvements, as well as a considerable reduction of the weight of the device:

These advantages were attained because of the modification on the upper structural member (1.5), particularly the removal of sharp corners or edges, which makes possible a better distribution of forces throughout the structure, and further the elimination of possible damages in the surfaces where the device is installed. The total length of the device was reduced, however, the height of the device was increased to optimize its mechanical efficiency. Obviously, the device, as well as its respective parts, can have varied sizes depending on the different uses, maintaining the same dimensional proportions.

Fewer parts and simplicity of the members, and therefore, a lower maintenance cost, a lower assembly cost, a greater flexibility concerning the suppliers and an easy maintenance due to the use of the same parts for multiple purposes;

It is clearly understood that different types of materials can be used for manufacturing different parts of the device, depending on the different uses, the loads that the device must support, and the type of the ground (surfaces) where the objects will slide.

Additionally, according to the present utility model, there is disclosed a method for fitting the parts of the multi-directional ball caster-type device (1), the method comprising the following steps:
a) inserting a lower ring of secondary rolling balls (1.2) into at least one groove or recessed area (1.41) of the lower structural member (1.4);
b) fixing a set comprising the lower structural member (1.4) and the lower ring of secondary rolling balls (1.2), obtained in step a, to the object in which the device (1) is to be installed;
c) fitting the main rolling ball (1.1) to the structure obtained in step b;
d) inserting an upper ring of secondary rolling balls (1.3) into at least one groove or recessed area (1.51) of the upper structural member (1.5);
e) fixing the set comprising the upper structural member (1.5) and the upper ring of secondary rolling balls (1.3), obtained in step d, to the object in which the device (1) is to be installed, aligning the fixing holes; and
f) providing the interlocking of the lower structural member (1.4) and the upper structural member (1.5), fixed to the object in which the device (1) is installed, by means of two fixing elements, such as a rivet-type element.

It must be understood that variations, modifications and changes of the utility model herein disclosed will be apparent to those skilled in this art, and they may be made without departing from the sprit and the scope of the present utility model or its equivalents, as encompassed by the appended claims and their equivalents.

The invention is further described by the following numbered paragraphs:
1. Multi-directional ball caster-type device (1), characterized in that it comprises:
   a lower structural member (1.4);
   at least one lower ring of rolling balls (1.2);
   an upper structural member (1.5);
   at least one upper ring of rolling balls (1.3); and
   a main rolling ball (1.1),
      wherein said main rolling ball (1.1) is enclosed by the lower and upper structural members (1.4, 1.5); said lower structural member (1.4) has at least one lower groove (1.41) in which said lower ring of rolling balls (1.2) is inserted, and an opening (1.42), which diameter is smaller than the diameter of the main rolling ball (1.1), and through which a portion of said main rolling ball (1.1) contacts the ground; said upper structural member (1.5) has at least one upper groove (1.51) in which said upper ring of rolling balls (1.3) is inserted, and a chamber (1.52) in which the main rolling ball (1.1) is arranged.
2. Multi-directional ball caster-type device (1), according to claim 1, characterized in that each one of said rings of rolling balls (1.2, 1.3) comprises an enveloped set of secondary rolling balls (1.21, 1.31) and/or a thin tape that immobilizes said secondary rolling balls (1.21, 1.31).
3. Multi-directional ball caster-type device (1), according to claim 2, characterized in that said thin tape has the shape of said rings with a preset size and/or wherein, after finishing the installation procedure of the device (1), said thin tape decomposes due to the rolling of said device (1).
4. Multi-directional ball caster-type device (1), according to at least one of the preceding claims, characterized in that it is possible to have a slope of the device (1) at an angle of 60°, or less, and preferably 50°, or less.
5. Multi-directional ball caster-type device (1), according to at least one of the preceding claims, characterized in that the diameter of said lower rings of secondary rolling balls (1.21, 1.31) is smaller than the diameter of the main rolling ball (1.1).
6. Multi-directional ball caster-type device (1), according to at least one of the preceding claims, characterized in that the diameter of said upper ring of secondary rolling balls (1.21, 1.31) is smaller than the diameter of the main rolling ball (1.1).
7. Multi-directional ball caster-type device (1), according to at least one of the preceding claims, characterized in that a diameter of said lower ring of secondary balls and a diameter of said upper ring of balls differ from each other.
8. Multi-directional ball caster-type device (1), according to claim 7, characterized in that a diameter of said lower ring of secondary balls is greater than a diameter of said upper ring of balls.
9. Multi-directional ball caster-type device (1), according to at least one of the preceding claims, characterized in that the secondary balls have a distance to each other which is greater than 10% of the diameter of the secondary balls, preferably greater than 20% of the diameter of the secondary balls and most preferably greater than 30% of the diameter of the secondary balls.
10. Multi-directional ball caster-type device (1), according to at least one of the preceding claims, characterized in that each one of said secondary rolling balls (1.21, 1.31) of the set of balls has the same size.
11. Multi-directional ball caster-type device (1), according to at least one of the preceding claims, characterized in that each one of said secondary rolling balls (1.21, 1.31) are made of the same material.
12. Multi-directional ball caster-type device (1), according to any one of claims 1 to 7, characterized in that said main rolling ball (1.1) and/or said secondary rolling balls (1.21, 1.31) are made of a light material having a low friction coefficient.
13. Multi-directional ball caster-type device (1), according to the preceding claim, characterized in that the material is selected from a group of materials containing tungsten, aluminum, carbon steel alloys and even some non-metallic materials.
14. Multi-directional ball caster-type device (1), according to at least one of the preceding claims, characterized in that it is designed lubricant free.
15. Multi-directional ball caster-type device (1), according to at least one of the preceding claims, characterized in that, when the slope angle of the device (1) decreases, the distance between the device (1) and the edge of the object to which the device (1) is to be fitted increases.

1. Multi-directional ball caster-type device comprising:
a lower structural member;
at least one lower ring of rolling balls;
an upper structural member;
at least one upper ring of rolling balls; and
a main rolling ball;
said main rolling ball being enclosed by the lower and upper structural members wherein said lower structural member has at least one lower groove in which said lower ring of rolling balls is inserted, and an opening, which diameter is smaller than the diameter of the main rolling ball, and through which a portion of said main rolling ball contacts the ground; said upper structural member has at least one upper groove in which said upper ring of rolling balls is inserted, and a chamber in which the main rolling ball is arranged.

2. Multi-directional ball caster-type device, according to claim 1, characterized in that each one of said rings of rolling balls comprises an enveloped set of secondary rolling balls or a thin tape that immobilizes said secondary rolling balls.

3. (canceled)

4. Multi-directional ball caster-type device, according to at least one of the preceding claims, characterized in that it has a slope of the device at an angle of 60°, or less.

5. Multi-directional ball caster-type device, according to claim 1, characterized in that the diameter of said lower rings of secondary rolling balls is smaller than the diameter of the main rolling ball.

6. Multi-directional ball caster-type device, according to claim 1, characterized in that the diameter of said upper ring of secondary rolling balls is smaller than the diameter of the main rolling ball.

7. Multi-directional ball caster-type device, according to claim 1, characterized in that a diameter of said lower ring of secondary balls and a diameter of said upper ring of balls differ from each other.

8. Multi-directional ball caster-type device, according to claim 7, characterized in that a diameter of said lower ring of secondary balls is greater than a diameter of said upper ring of balls.

9. Multi-directional ball caster-type device, according to claim 1, characterized in that the secondary balls have a distance to each other which is greater than 10% of the diameter of the secondary balls.

10. Multi-directional ball caster-type device, according to claim 1, characterized in that each one of said secondary rolling balls (1.21, 1.31) of the set of balls has the same size.

11. Multi-directional ball caster-type device, according to claim 1, characterized in that each one of said secondary rolling halls are made of the same material.

12. Multi-directional ball caster-type device (1), according to claim 1, characterized in that said main rolling ball (1.1) and said secondary rolling balls (1.21, 1.31) are made from a material selected from a group of materials containing tungsten, aluminum, carbon steel alloys and even some non-metallic materials.

13. (canceled)

14. (canceled)

15. Multi-directional ball caster-type device, according to claim 4, characterized in that, when the slope angle of the device decreases, the distance between the device (1) and the edge of the object to which the device is to be fitted increases.
